(19) United States
(12) Patent Application Publication
(10) Pub. No.: US 2025/0168572 A1
(43) Pub. Date: May 22, 2025

(54) HEARING DEVICE WITH ACTIVE NOISE CANCELLATION

(71) Applicant: Oticon A/S, Smørum (DK)

(72) Inventors: Michael Syskind PEDERSEN, Smørum (DK); Mirjana ADNADJEVIC, Ballerup (DK); Nels Hede ROHDE, Smørum (DK); Daniel PLEWE, Smørum (DK); Søren Pyndt JØRGENSEN, Smørum (DK); Svend Oscar PETERSEN, Smørum (DK)

(21) Appl. No.: 18/953,117

(22) Filed: Nov. 20, 2024

(30) Foreign Application Priority Data
Nov. 21, 2023 (EP) 23211126.0

(51) Int. Cl. H04R 25/00

(52) U.S. Cl. CPC H04R 25/453; H04R 2460/01

(57) ABSTRACT

Disclosed herein are embodiments of a method of operating a hearing aid with an active noise control system. The method can utilize an ambient sound detector for classification of an ambient sound environment, such as a coherence measure between audio signals. The method can further include mixing audio signals with a feed-forward compensating signal in dependence on the particular classification of the sound environment.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### FIELD

The present disclosure relates to hearing devices having active noise cancellation. More particularly, the disclosure relates to a method of controlling active noise cancellation in a device having first and second microphones.

### BACKGROUND

In document U.S. Pat. No. 10,586,523 B1, the entirety of which is hereby incorporated by reference, a wind noise detector is used to control the feed-forward gain of an ANC system. However, this has a number of limitations.

Therefore, there is a need to provide a solution that addresses at least some of the above-mentioned problems. The present disclosure provides at least an alternative to the prior art.

### SUMMARY

According to an aspect, the present disclosure provides a method of operating a hearing device comprising an active noise control (ANC) system, the hearing device being configured to be placed at an ear of a wearer, the hearing device comprising a microphone system comprising two microphones. Advantageously, the two microphones would be arranged outside the ear canal of the wearer when the hearing device is worn. Such a method may be beneficial for use in hearing aids. The method may comprise capturing audio with the microphone system. The microphone system may be configured as a directional microphone system, or be configured to provide signals allowing a directional signal to be established. The method may comprise generating audio signals based on the captured audio. The audio signals originate from an input system comprising one or more input transducers. The signal from such an input transducer is converted into a processable signal, such as a time-frequency unit. The term ‘signals’ is to be understood as This could be or include analogue to digital conversion. The method may comprise providing the audio signals to an ambient sound detector. Such ambient detector may include one or more level detectors, one or more frequency analyzers, etc. The method may comprise determining, using the ambient sound detector, a classification of ambient sound environment based on the audio signals, wherein the classification may include determining a coherence measure between at least two of the audio signals. The method may comprise providing the audio signals to the ANC system, the ANC system generating, based on the audio signals, a feed-forward compensating signal. The method may comprise mixing the audio signals with the generated feed-forward compensating signal at a ratio of the generated feed-forward compensating signal in dependence of the determined classification of the sound environment. Mixing the feed-forward compensating signal based at least partly on ambientness provides an improved noise control in the signal provided to the user.

Advantageously, the microphone system may be configured so that a first microphone is positioned at a position external to an ear canal of the ear and a second microphone is positioned at a position internal to the ear canal of the ear. Such a configuration is contemplated to provide an improved performance of the noise control system.

Advantageously, the method may further comprise the classification including or being a measure of ambientness. Looking to ambientness over a measure such as wind nose, have proven to improve the performance of the noise control system.

The present inventors have realized that it is advantageous to not control an active noise control system based on noise sources which are not from the environment of the hearing aid user, such noise sources include wind noise and handling noise. By using a coherence measure between (at least) two input transducers oriented towards the environment, it is possible to achieve an improved active noise control. It is in particular advantageous if the ambientness is not based on or includes any kind of estimation of error or residual noise signal, such as from the ear canal of the user. Advantageously, ambientness is determined based on signals from two or more input transducers positioned outside the ear canal of the user when the hearing device, or hearing aid, is placed at the ear of the user.

Advantageously, ambientness is determined based only on signals from two or more input transducers positioned outside the ear canal of the user when the hearing device, or hearing aid, is placed at the ear of the user. Advantageously, ambientness is determined based on signals from two or more input transducers positioned outside the ear canal of the user, such as facing away from the user's head, when the hearing device, or hearing aid, is placed at the ear of the user. Advantageously, ambientness is determined without influence of an error signal based on an ear canal input transducer.

Advantageously, the method may further comprise that ambientness is represented as a value in the interval [0:1].

Advantageously, the method may further comprise that the classification of ambient sound environment is performed for frequencies below 3 kHz. Excluding higher frequencies eliminate certain sources of error and thus improve the performance of noise control.

Advantageously, the method may further comprise that the classification of ambient sound environment is based on or includes the coherence measure determined for each of, or a subset of, a number of frequency bands.

Advantageously, the method may further comprise that the classification of ambient sound environment is further based on one or more of: level, detection of presence of own voice, coherence measure between at least one frequency band of each of the audio signals. Adding further parameters to the decision is contemplated to make the decision making more accurate, or at least more specific.

Advantageously, the method may further comprise that the coherence measure may be determined for at least two neighboring frequency channels, or at least two non-neighboring frequency channels. If the coherence measure is determined over more than one channel, it is contemplated that the coherence measure is more accurately determined.

Advantageously, the method may further comprise that the classification of ambient sound environment may be performed using a linear and/or a non-linear combination of more than one input from the ambient sound detector.

Advantageously, the method may further comprise that the ambient sound detector may comprise a trained network trained using sound from a first group being classified as ambient sound which includes one or more of: background noise, speech, music and/or machine noise and a second group being classified as non-ambient sound and including one or more of: own voice, handling noise, wind noise, low level sounds.

Advantageously, the method may further comprise that the input to the trained network of the ambient sound detector is or includes the coherence measure. Generally, the hearing aid may comprise a neural network. The neural network may comprise model layers for processing of the electric input signal, or a signal based thereon to provide a processed electric signal. The model layers may comprise an input layer, one or more intermediate layers, and an output layer. Each layer may comprise one or more nodes. The input layer of the neural network may be viewed as the layer where data is fed into the neural network. Each node in the input layer may represent a feature of the input data. The one or more intermediate layers may perform various computations and transformations on the input data to extract features and patterns. Each node in the one or more intermediate layers may receive one or more inputs from the previous layer, determine a weighted sum based on the one or more inputs from the previous layer, add a bias to the weighted sum to determine a result, and then pass the result through an activation function to introduce non-linearity. The output layer may be viewed as the final layer that produces the network's predictions or outputs. Each node in the output layer may correspond to a possible output or class label.

The neural network may be a trained neural network. To train the neural network, the neural network may be initialized with initial values for parameters of the neural network, such initialization may be carried out by known methods, e.g., Xavier initialization or He initialization, alternatively, the neural network may be initialized with parameters determined during a prior training session of the neural network. The initialized neural network may be provided with training data to produce one or more outputs. The training data may be provided as labelled data, or unlabeled data. The training data may be provided in pairs, each pair comprising an input sample to be provided as an input to the neural network, and a ground truth. The one or more outputs of the neural network may be provided to a cost function configured to determine a cost based on the difference between the one or more outputs of the neural network and a target. The target may be provided as part of the training data, e.g., as the ground truth or a label associated with the data. The target may be a target value, e.g., a mean opinion score or a signal to noise ratio. To train the neural network one or more parameters of the neural network are adjusted to minimize the cost of the cost function. The one or more parameters of the neural network may be adjusted according to an optimization algorithm, such as stochastic gradient descent, or Levenberg-Marquardt optimization. Training of the neural network may be iterated over multiple epochs. Each epoch may comprise passing the entire training dataset through the network and updating the neural network parameters accordingly.

A further aspect of the present disclosure relates to a hearing device which comprises a housing configured to be placed at an ear of a wearer. The hearing device may comprise a microphone system comprising two microphones. Such microphone system may be configured to capturing audio and to generating audio signals based on the captured audio. The conversion to audio signals may be performed by an AD converter or the like, either included in or connected to the microphone system. The hearing device may comprise an ambient sound detector configured to receive the audio signals and the ambient sound detector further configured to determining a classification of ambient sound environment based on the audio signals. In such a classification, the classification may include determining a coherence measure between at least two of the audio signals, or parts thereof or signals derived of the audio signals or derived from parts of the audio signals. The hearing device may comprise an active noise control system (ANC), which is configured for receiving the audio signals, the ANC system being configured for generating, based on the audio signals, a feed-forward compensating signal. The hearing device may be configured for or to mixing the audio signals, or signals derived therefrom, with the generated feed-forward compensating signal at a ratio of the generated feed-forward compensating signal in dependence of the determined classification of the sound environment.

Further, the hearing device may be configured to establish a hearing loss compensated signal based on signals from the microphone system, or signals derived therefrom. The hearing loss compensated signal may be established in a sound processor. The hearing loss compensated signal may amplify or dampen signals in one or more frequency bands, frequency shift signals, transpose signals, noise reduction, directionality, or perform other hearing loss compensation processing in order to provide the user/wearer with a signals that is perceivable as sound.

The hearing device may comprise the microphone system being configured so that a first microphone is positioned at a position external to an ear canal of the ear and a second microphone is positioned at a position internal to the ear canal of the ear.

The hearing device may comprise that the ambient sound detector comprises a trained network trained using sound from a first group being classified as ambient sound which includes one or more of: background noise, speech, music and/or machine noise and a second group being classified as non-ambient sound and including one or more of: own voice, handling noise, wind noise, low level sounds.

The hearing device may comprise that the trained network is a neural network with 4 layers. One or more of the above advantages may be combined.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 schematically illustrates a hearing aid,

FIG. 2 schematically illustrates components of a hearing aid having two microphones,

FIG. 3 schematically illustrates components of a hearing aid having three microphones, where one microphone is located in the ear canal and two are located behind the pinna,

FIG. 4 schematically illustrates graphs of coherence value as a function of frequency,

FIG. 5 schematically illustrates GFF as function of the amount of ambientness,

FIG. 6 schematically illustrates Ambiance being a function of multiple inputs,

FIG. 7 schematically illustrates an exemplified structure of a (feed-forward) neural network, and

FIG. 8 schematically illustrates examples of training data.

### DETAILED DESCRIPTION

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

A hearing device (or hearing instrument, hearing assistance device) may be or include a hearing aid that is adapted to improve or augment the hearing capability of a user by receiving an acoustic signal from a user's surroundings, generating a corresponding audio signal, possibly modifying the audio signal and providing the possibly modified audio signal as an audible signal to at least one of the user's ears. ‘Improving or augmenting the hearing capability of a user’ may include compensating for an individual user's specific hearing loss. The “hearing device” may further refer to a device such as a hearable, an earphone or a headset adapted to receive an audio signal electronically, possibly modifying the audio signal and providing the possibly modified audio signals as an audible signal to at least one of the user's ears. Such audible signals may be provided in the form of an acoustic signal radiated into the user's outer ear, or an acoustic signal transferred as mechanical vibrations to the user's inner ears through bone structure of the user's head and/or through parts of the middle ear of the user or electric signals transferred directly or indirectly to the cochlear nerve and/or to the auditory cortex of the user.

The hearing device may be adapted to be worn in any known way. This may include i) arranging a unit of the hearing device behind the ear with a tube leading air-borne acoustic signals into the ear canal or with a receiver/loudspeaker arranged close to or in the ear canal and connected by conductive wires (or wirelessly) to the unit behind the ear, such as in a Behind-the-Ear type hearing aid, and/or ii) arranging the hearing device entirely or partly in the pinna and/or in the ear canal of the user such as in an In-the-Ear type hearing aid or In-the-Canal/Completely-in-Canal type hearing aid, or iii) arranging a unit of the hearing device attached to a fixture implanted into the skull bone such as in a Bone Anchored Hearing Aid, or iv) arranging a unit of the hearing device as an entirely or partly implanted unit such as in a Bone Anchored Hearing Aid. The hearing device may be implemented in one single unit (housing) or in a number of units individually connected to each other.

A “hearing system” refers to a system comprising one or two hearing devices, and a “binaural hearing system” refers to a system comprising two hearing devices where the devices are adapted to cooperatively provide audible signals to both of the user's ears. The hearing system or binaural hearing system may further include one or more auxiliary device(s) that communicates with at least one hearing device, the auxiliary device affecting the operation of the hearing devices and/or benefitting from the functioning of the hearing devices. A wired or wireless communication link between the at least one hearing device and the auxiliary device is established that allows for exchanging information (e.g. control and status signals, possibly audio signals) between the at least one hearing device and the auxiliary device. Such auxiliary devices may include at least one of a remote control, a remote microphone, an audio gateway device, a wireless communication device, e.g. a mobile phone (such as a smartphone) or a tablet or another device, e.g. comprising a graphical interface, a public-address system, a car audio system or a music player, or a combination thereof. The audio gateway may be adapted to receive a multitude of audio signals such as from an entertainment device like a TV or a music player, a telephone apparatus like a mobile telephone or a computer, e.g. a PC. The auxiliary device may further be adapted to (e.g. allow a user to) select and/or combine an appropriate one of the received audio signals (or combination of signals) for transmission to the at least one hearing device. The remote control is adapted to control functionality and/or operation of the at least one hearing device. The function of the remote control may be implemented in a smartphone or other (e.g. portable) electronic device, the smartphone/electronic device possibly running an application (APP) that controls functionality of the at least one hearing device.

In general, a hearing device includes i) an input unit such as a microphone for receiving an acoustic signal from a user's surroundings and providing a corresponding input audio signal, and/or ii) a receiving unit for electronically receiving an input audio signal. The hearing device further includes a signal processing unit for processing the input audio signal and an output unit for providing an audible signal to the user in dependence on the processed audio signal.

The input unit may include multiple input microphones, e.g. for providing direction-dependent audio signal processing. Such directional microphone system is adapted to (relatively) enhance a target acoustic source among a multitude of acoustic sources in the user's environment and/or to attenuate other sources (e.g. noise). In one aspect, the directional system is adapted to detect (such as adaptively detect) from which direction a particular part of the microphone signal originates. This may be achieved by using conventionally known methods. The signal processing unit may include an amplifier that is adapted to apply a frequency dependent gain to the input audio signal. The signal processing unit may further be adapted to provide other relevant functionality such as compression, noise reduction, etc. The output unit may include an output transducer such as a loudspeaker/receiver for providing an air-borne acoustic signal transcutaneously or percutaneously to the skull bone or a vibrator for providing a structure-borne or liquid-borne acoustic signal. In some hearing devices, the output unit may include one or more output electrodes for providing the electric signals such as in a Cochlear Implant.

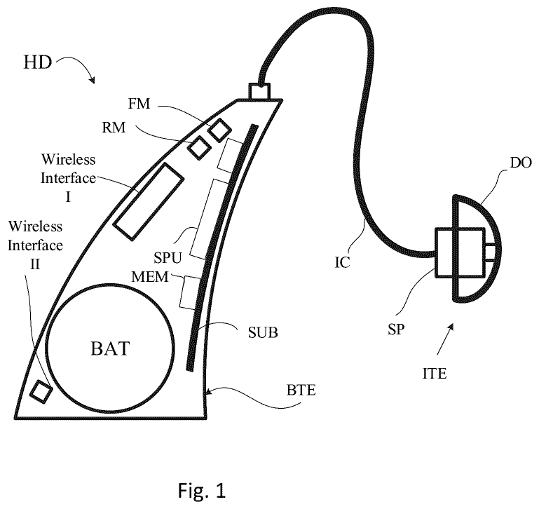

FIG. 1 schematically illustrates a hearing device HD comprising a behind-the-ear housing, BTE, which is configured to be positioned in the area between the pinna and the skull of a user.

The BTE comprises the majority of electronic components of the hearing device, such as microphone system comprising first and second microphones, FM and RM, processor SPU, memory MEM, power source BAT, wireless interface(es) I and II, however, one or more of these components may be located in or distributed across other parts, such as an In-The-Ear housing/part ITE. The ITE part comprises an output transducer SP, which is configured to transform a processed electrical signal into a signal that the user may perceive as sound, such as air born audio. One or more of the electronic components may be arranged in connection with or on a substrate SUB. The power source BAT may be a primary or secondary battery, i.e. replaceable or rechargeable. The recharging may be contact charging or wireless charging.

The wireless interface may include an inductively-based system comprising a coil configured for reception and/or transmission of low frequency signals, such as magnetic induction signals, e.g. to/from a hearing device located contralaterally.

The wireless interface may include an RF-frequency based system, comprising a radio frequency antenna, e.g., an antenna configured for reception and/or transmission at around 2.4 GHz.

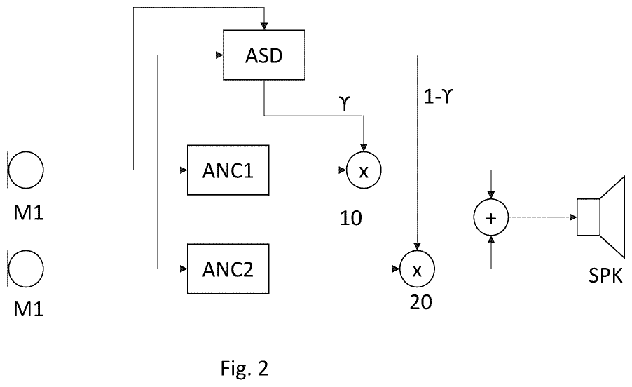

FIG. 2 schematically illustrates part of the hearing device HD where two microphones, here denoted M1 and M2, which could correspond to the microphones FM and RM in FIG. 1 but could also refer to a system where one microphone was positioned at the BTE and one microphone positioned at the ITE.

The two microphones, M1 and M2, capture audio. Here the two microphones constitute the entire microphone system, however, the microphone system could comprise further microphones, which are not illustrated here. The audio signals captured by the individual microphones M1 and M2 are fed to an active noise controller, ANC1 and ANC2 respectively. These ANC components are configured each to provide a feed-forward compensation signal.

The purpose of the active noise control system (ANC) in a hearing device is to cancel the direct sound originating from primary noise source (P) that reaches eardrum.

Further, the signals from the microphone system, M1 and M2, is forwarded to an ambient sound detector, ASD. The ambient sound detector ASD may use one or more of a range of measures to establish a measure of the ambient sound conditions for the hearing device. Examples include detection of own voice, the sound level in general or in one or more specific frequency bands, presence or level of wind noise.

At the respective points, the audio signal is mixed with the generated feed-forward compensating signal at a given ratio. Here the ratio is determined at the ASD. The generated feed-forward compensating signal is dependent on the determined classification of the sound environment. The output from the ambient sound detector ASD is used to control the ratio at which the feedforward compensated signals are mixed at.

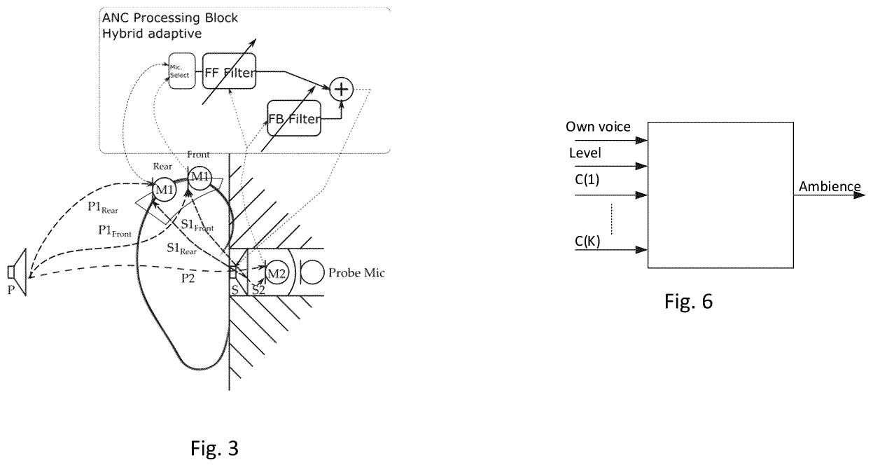

It is considered advantageous if the ambient sound detector is configured to determine or use a coherence measure between the microphones of the microphone system. This means that if the microphone system comprises two microphones, as illustrated in FIGS. 1 and 2, a coherence measure may be calculated or determined in one or more frequency bands for the two microphone signals. If the microphone system comprises more than two microphones, such as three microphones, coherence may be determined or calculated between a set of microphones. In FIG. 3 this is illustrated by a hearing device having a microphone system comprising two microphones, M1, located outside the ear canal, here behind the ear, and one microphone M2 in the ear canal. A selection is then made on which of the two outside microphones M1 is to be used for the coherence measure relative to the in-the-ear microphone. The in-the-ear microphone could either be facing the ear drum or the environment.

FIG. 3 schematically illustrates an ANC system realized as hybrid, meaning that both feed-forward (FF) and feedback (FB) ANC methods are used.

An FF ANC system uses the input from microphone(s) M1 (front and/or rear in combination or alone) to predict the direct sound at the eardrum. The phase of the predicted signal is inverted in order to obtain an anti-noise signal to cancel the direct sound. The anti-noise signal(S) is generated by the FF filter and played back through the receiver in the ear.

In a hearing device which also has a microphone in the ear (M2), FF ANC is realized as an adaptive process, where input from the M2 microphone is aiding the input of the microphone(s) M1 in order to achieve a more accurate prediction of the noise close to the eardrum. Even though shown here in FIG. 3, the M2 microphone is optional is some instances. The M2 microphone could be present physically but, selectively or entirely, not included in the establishment of an ANC signal. Currently, it is, however, preferred that the M2 microphone is present and included in the system.

The success of the FF ANC system is highly dependent on the coherence measure between the primary field at the microphone(s) M1 and eardrum location, therefore also microphone M2. Higher coherence means a better relationship between M1 and M2, hence the better the input from the microphone(s) M1 can be used to explain the field at the microphone M2.

In practice, the benefit of an FF ANC system is best observed for those frequencies that show the coherence that is equal or higher than 0.8.

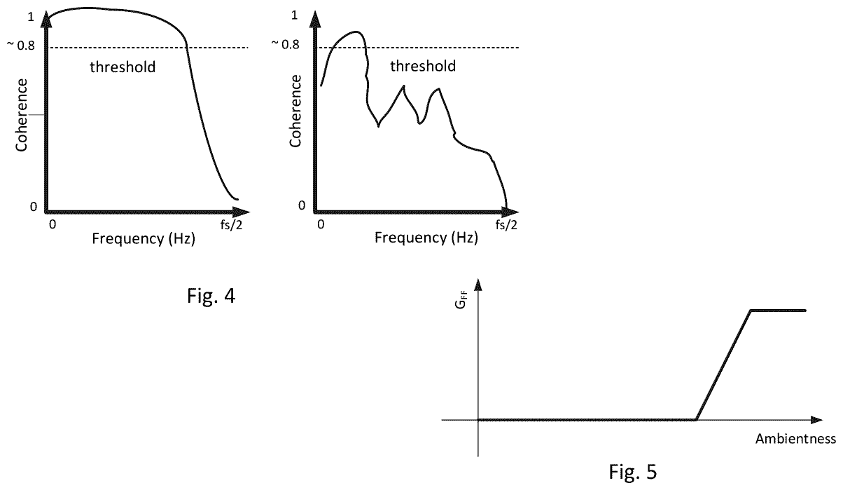

FIG. 4 illustrates the examples of two possible coherence situations between microphone(s) M1 and M2 over a given frequency range. The example on the left illustrates that the coherence for most of the frequencies (possibly divided in frequency bands) is above a threshold of 0.8, meaning that microphone(s) M1 can be, to a good extent, used to predict the field at the microphone M2, i.e. in the ear canal near the eardrum. On the righthand, the other example illustrates the coherence, which is way below the mentioned threshold for most frequencies/frequency bands, which results in that the sound field at the microphone(s) M1 cannot sufficiently be used to predict the sound field at microphone M2/in the ear canal. This further means that FF ANC system would fail to a large extend in that example.

Moreover, the FF system would probably be more harmful than beneficial. Relating this to the environments encountered in the real world, so called ambient-sound-a-like environments would show the high coherence between microphone(s) M1 and M2 at the frequencies relevant for ANC, with an assumption that the location for reference microphone M1 is well chosen, and that the environment sound is reaching the eardrum. Contrary, the environments of more random nature, such as tapping, handling sounds or wind or even own voice, will to the great extend show uncorrelation between mentioned microphones. In the case of own voice, a different correlation and/or relation between the microphone and the eardrum will be present.

The FB ANC system is using the input from the microphone M2 and feeds that input back through the feedback filter (FB Filter) to the receiver in the ear. The receiver produces the anti-noise field S that should ideally cancel the field at the microphone M2, in the ear canal. This principle is mainly limited by the allowed gain before the system becomes unstable and starts oscillating. The FB ANC can also be realized as an adaptive process where the FB filter tries to adapt to the changes in the S2 path to keep the overall FB system stable. Contributions of both FF and FB ANC system are combined and played back from the receiver in the ear, as depicted in FIG. 3.

As described above, one problem for the FF ANC system arises when reference microphone M1 cannot predict well the direct sound field in the eardrum, meaning that coherence between the microphone M1 and M2 has deteriorated. In those situations, it is desirable to reduce the contribution of FF ANC system. For the hybrid system, this would mean fading the system into FB ANC, while for the system based on the FF ANC only, this would mean reducing/switching off ANC.

The present disclosure provides an ANC system where the FF ANC contribution is controlled by a so-called ambient sound detector block by means of gain GFF. In the present system an ambient noise detector is used. The ambient sound detector, among other things, uses the coherence measure between the microphones M1 and M2 to decide on how much FF ANC, and therefore gain GFF, is desirable. If the coherence between the microphones M1 and M2 is above a certain threshold (in other words if ambientness is high), the gain GFF is increased. Otherwise, the gain GFF is reduced. The gain GFF may also depend on other input such as the sound input level.

FIG. 5 illustrates GFF as function of the amount of ambientness. When we see low amount of ambientness between the microphones, the GFF gain is reduced. The ambient sound estimate may be a function of the coherence between the microphones.

Surprisingly it has been found advantageous, in some instances, to limit the ambient sound detector to measure or determine the level of ambientless by including coherence at frequencies below 3 kHz.

Further, or alternatively, the ambient sound detector may base the on frequency-weighted coherence across different frequency sub-bands.

As illustrated in FIG. 6, the ambientness could be determined based on a range of inputs, such as level, own voice and coherence across different frequency bands 1 . . . . K. The combination of different input into an ambience measure may be linear or non-linear. The combination unit may contain a neural network based on labelled input data (ambient/non-ambient

The use of a trained neural network has shown to be advantageous for determining the ambientness. For such a trained network, the input features may comprise microphone signal(s), and/or coherence measures estimated from the microphone signals.

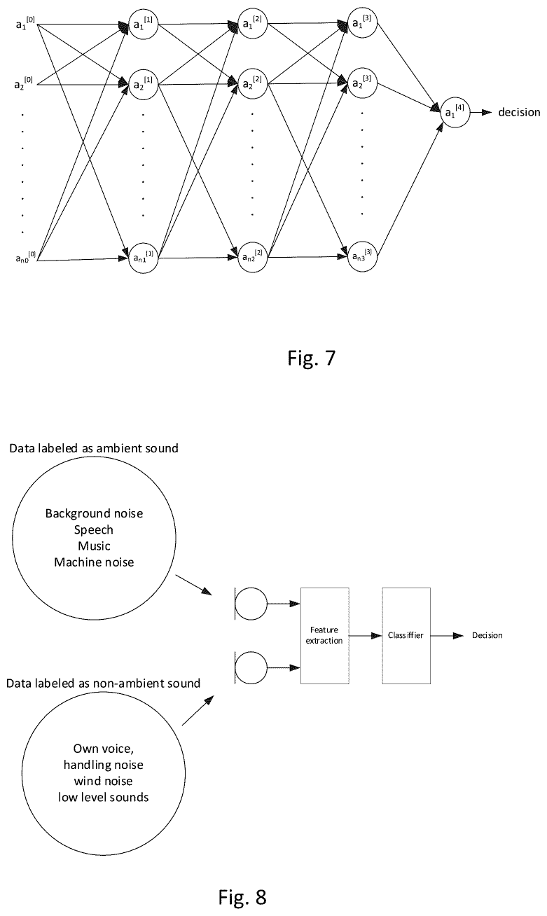

FIG. 7 schematically illustrates an exemplified structure of a (feed-forward) neural network with M=4 layers. The input signal is passed through a number of nonlinear layers of type a[l]=f (Wa[l−1]+b). The final output layer is a decision layer classifying the input sounds either as ambient sound or not ambient sound. Based on the set of training data, the weights W and biases b are trained in order to maximize the discrimination between ambient and non-ambient sound.

FIG. 8 schematically illustrates examples of training data either labelled as ambient or non-ambient sound. Audio examples are labeled based on how well it is expected that an active noise cancelling system can handle the sound. For that reason, it is preferred that the hearing device contains at least two microphones, as a coherence or correlation measure between the microphones may be an important feature for an ambient sound detector. The input signals are fed into a feature extraction unit, which provides features to the classifier unit (e.g. a trained neural network). The feature extraction unit may contain a filter bank. Features may also be derived by adding or subtracting of the input signals. Derived features may be correlation or coherence measures between microphone signals or level estimates.

Ambient sound processing block could be a part of a hearing device processing block, i.e. the hearing loss compensation processing, which run in parallel with ANC processing block. This block runs at a slower rate than ANC processing block and is possibly in charge of performing Noise Reduction, Hearing Loss Compensation, Sound environment reproduction, Beamforming, Speech detection, different control measures etc.

In order for being able to distinguish own voice from ambient sound(s), the hearing device, or the ambient sound detector, comprise an own voice detector or is configured to receive signals from such a detector.

The ambient sound detector is configurable to assess the ambience of each microphone (M1 front, M1 rear . . . ) separately or combined. As mentioned, the ambience may be based on the coherence between M1 and M2, i.e. between an outer microphone and an in-the-ear/canal microphone. In the case where M2 is absent, the (outer) microphone with highest ambience may be selected based on an instant level comparison between each microphone, e.g. the microphone with the lowest level. Depending on the selected microphone, different ANC filters may be chosen.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise.

Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects. Reference to an element in the singular is not intended to mean “one and only one” unless specifically so stated, but rather “one or more.” Unless specifically stated otherwise, the term “some” refers to one or more.

Accordingly, the scope should be judged in terms of the claims that follow.

1. A method of operating a hearing device comprising an active noise control (ANC) system, the hearing device being configured to be placed at an ear of a wearer, the hearing device comprising a microphone system comprising two microphones arranged in relation to the hearing device and being configured at a location of the hearing device outside the ear canal of the wearer when the hearing device is worn, wherein the method comprises:
capturing audio with the microphone system,
generating audio signals based on the captured audio,
providing the audio signals to an ambient sound detector,
determining, using the ambient sound detector, a classification of ambient sound environment based on the audio signals from the two external microphones, wherein the classification includes determining a coherence measure between at least two of the audio signals,
providing the audio signals to the ANC system, the ANC system generating, based on the audio signals, a feed-forward compensating signal,
mixing the audio signals with the generated feed-forward compensating signal at a ratio of the generated feed-forward compensating signal in dependence of the determined classification of the sound environment.

2. The method according to claim 1, wherein the microphone system being configured so that a first microphone is positioned at a position external to an ear canal of the ear of the wearer and a second microphone is positioned at a position internal to the ear canal of the ear of the wearer.

3. The method according to claim 1, wherein the classification includes or is a measure of ambientness.

4. The method according to claim 3, wherein ambientness is represented as a normalized value in the interval [0:1].

5. The method according to claim 1, wherein the classification of ambient sound environment is performed for frequencies below 3 kHz.

6. The method according to claim 1, wherein the classification of ambient sound environment is based on or includes the coherence measure determined for each of, or a subset of, a number of frequency bands.

7. The method according to claim 1, wherein the classification of ambient sound environment is further based on one or more of: level, detection of presence of own voice, coherence measure between at least one frequency band of each of the audio signals.

8. The method according to 6, wherein coherence measure is determined for at least two neighboring frequency channels, or at least two non-neighboring frequency channels.

9. The method according to claim 1, wherein the classification of ambient sound environment is performed using a linear and/or a non-linear combination of more than one input from the ambient sound detector.

10. The method according to claim 1, wherein the ambient sound detector comprises a trained network trained using sound from a first group being classified as ambient sound which includes one or more of: background noise, speech, music and/or machine noise and a second group being classified as non-ambient sound and including one or more of: own voice, handling noise, wind noise, low level sounds.

11. The method according to claim 10, wherein the input to the trained network of the ambient sound detector is or includes the coherence measure.

12. A method of operating a hearing device comprising an active noise control (ANC) system, the hearing device being configured to be placed at an ear of a wearer, the hearing device comprising an input system comprising two input transducers arranged external to the ear canal of the wearer when the hearing device is worn at or in the ear, wherein the method comprises:
capturing audio with the input system,
generating audio signals based on the captured audio,
providing the audio signals to an ambient sound detector,
determining, using the ambient sound detector, a classification of ambient sound environment based on the audio signals from the two external input transducers, wherein the classification includes determining a coherence measure between the audio signals from the two external input transducers,
providing the audio signals to the ANC system, the ANC system generating, based on the audio signals, a feed-forward compensating signal,
mixing the audio signals with the generated feed-forward compensating signal at a ratio of the generated feed-forward compensating signal in dependence of the determined classification of the sound environment.

13. A hearing device comprising a housing configured to be placed at an ear of a wearer, wherein the hearing device comprises:
a microphone system comprising two microphones arranged outside the ear canal of the wearer when the hearing device is being worn, wherein the microphone system is configured to capturing audio and to generating audio signals based on the captured audio,
an ambient sound detector configured to receive the audio signals and the ambient sound detector further configured to determining a classification of ambient sound environment based on the audio signals, wherein the classification include determining a coherence measure between at least two of the audio signals,
an active noise control system (ANC), which is configured for receiving the audio signals, the ANC system being configured for generating, based on the audio signals, a feed-forward compensating signal,
the hearing device being configured for mixing the audio signals with the generated feed-forward compensating signal at a ratio of the generated feed-forward compensating signal in dependence of the determined classification of the sound environment.

14. The hearing device according to claim 13, wherein the microphone system being configured so that a first microphone is positioned at a position external to an ear canal of the ear and a second microphone is positioned at a position internal to the ear canal of the ear.

15. The hearing device according to claim 13, wherein the ambient sound detector comprises a trained network trained using sound from a first group being classified as ambient sound which includes one or more of: background noise, speech, music and/or machine noise and a second group being classified as non-ambient sound and including one or more of: own voice, handling noise, wind noise, low level sounds.

16. The hearing device according to claim 15, wherein the trained network is a neural network with 4 layers.
